(19) United States
(12) Patent Application Publication
(10) Pub. No.: US 2020/0074537 A1
(43) Pub. Date: Mar. 5, 2020

(54) REAL ESTATE PRODUCT RELATED FINANCE SYSTEM AND MANAGEMENT METHOD THEREOF

(71) Applicant: Chia-Yeh Hsu, Taipei City (TW)

(72) Inventor: Chia-Yeh Hsu, Taipei City (TW)

(21) Appl. No.: 16/373,645

(22) Filed: Apr. 3, 2019

(30) Foreign Application Priority Data
Aug. 31, 2018 (TW) 107130656
Dec. 17, 2018 (TW) 107145520

(51) Int. Cl. G06Q 40/02; G06Q 30/06; G06Q 30/02

(52) U.S. Cl. CPC G06Q 40/02; G06Q 30/0641; G06Q 50/16; G06Q 30/0239; G06Q 30/0629

(57) ABSTRACT

A real estate product related finance system and a management method thereof are provided. The finance system includes a finance organization server, a sale terminal and a real estate service platform. The finance organization server records loan information of customers, where the loan information includes loan interest. The sale terminal receives a deal processed through a purchase certificate, where the purchase certificate relates to digital money. The real estate platform calculates difference between deals by the purchase certificate and home loan interest of each customer within a liquidation period, and provides the difference to the finance organization server, to deduct the home loan interest within the liquidation period. Accordingly, mechanism for paying the home loan interest is changed, it is easier to manage for financial organizations, and the customer can be notified automatically.

### CROSS REFERENCE TO RELATED APPLICATION

This application claims the priority benefits of Taiwan application serial no. 107130656, filed on Aug. 31, 2018, and Taiwan application serial no. 107145520, filed on Dec. 17, 2018. The entirety of each of the above-mentioned patent applications is hereby incorporated by reference herein and made a part of specification.

### BACKGROUND OF THE DISCLOSURE

### Field of the Disclosure

The present disclosure relates to a finance management technique, and in particular, to a real estate product related finance system and a management method thereof

### Description of Related Art

General public's salary or deposit are usually insufficient to pay off the total price of real products, such as houses, lands, etc. Therefore, people having purchasing demands seek financial institutions for loans. The conventional financial institutions provide discounting mechanisms, such as low home loan interest rate (for example, discount interest rate for first-time home purchasers, and the current lowest interests for home loan being 1.65%), extending loan terms, etc. However, these discounting mechanisms take only a small portion for discounting home loan interest. Home loan customer demand to consider not only their affordability, but also their living economic issues, such as their old-age deposits, while they repay their loans. Therefore, the existing home loan discounting mechanisms fail to effectively attract home loan customers. In addition, since the discounts for interest rate and loan interest are too low, the loyalty of home loan customer toward the financial institutions is not good.

Regarding repaying the home loans, the general public usually repay by reaching the counter or remit the money to their home loan debit account. However, it is inevitable that they forget to do the payment. Nevertheless, in the existing mechanism, the financial institutions only notify the home loan customers after the liquidation period of the month is due. Under this mechanism, it is possible for the public to still forget to do the payment next time. The credit scores of the public is thus hurt, and the financial institutions are not able to receive the money on time.

Furthermore, in the conventional process for banks to undertake new home loans, the home loan amount and the home loan interest rate are usually audited based on the related house information (e.g., address, floor, building structure, construction year, area of usage, etc.) purchased by the purchaser, home loan customer's age and credit rating information (e.g., income, debt, or withholding certificate) after the deal between the purchaser and the seller has been completed. Moreover, some home loan auditing further includes determining whether the real estate is insured (residential fire and earthquake insurance), and the loan is made after passing the audit.

Currently, most banks have their own home loan pre-calculation system, and property and casualty insurance companies also have their own insurance pre-calculation system for the public to use. However, as the purchasers is still selecting among houses, they lack complete housing loan search information (for example, address, floor, building structure, construction year, area of usage, etc.) of each house. In addition, they fail to obtain related fees, such as home loan amount and home loan rate, and property insurance (e.g., residential fire and earthquake insurance) for each of the real estate in selection. Besides, the purchaser usually finds out that the audited home loan is not as expected while the real estate purchasing process is nearly completed. The gap between the amount of the applied loan amount and the actual audited loan amount is generated, which in turn evolves into a situation in which down payment is insufficient (and the property insurance fee is required to be paid). Nevertheless, at this time, the purchaser usually has paid a considerable amount of money for the house purchase (of the down payment). If the purchaser fails to prepare the money, the amount of the gap due to the insufficient audited loan eventually interrupts the purchaser's finance planning. Even if the bank's current practice, which lends the aforementioned (loan application and loan audit) gap by fiduciary loans, its interest rate (higher) and repayment period (shorter) also result in the financial burden of the purchaser's original house purchase plan. According to bank practitioners' experiences, in the process of applying for home loan, the home loan applicants are worried about purchasing at an expensive price owing to lack of information on the housing market. After paying deposit of the house, they are afraid that the loan amount is not as expected, and thus are unable to pay the down payment. However, real estate appraisal systems of conventional banks fail to immediately provide related information. It is acquired that an innovative financial management mechanism is necessary for real estate products.

### SUMMARY OF THE DISCLOSURE

In light of this, the present disclosure provides a real estate product related finance system and a management method thereof, in which a digital platform is provided, changing the conventional mechanism for repaying interest, facilitating management and collection for the financial institutions, and automatically reminding home loan customer.

A real estate product related finance system of the embodiment of this disclosure includes a finance organization server, a sale terminal, and a real estate service platform. The finance organization server records loan information of a customer, and the loan information includes loan interest. The sale terminal receives a deal proceeded through a purchase certificate, and the purchase certificate is related to digital money. The real estate service platform calculates a difference between deals by the purchase certificate and the corresponding home loan interest of each customer within a liquidation period, and provides the difference to the finance organization server to deduct the home loan interest within the liquidation period.

The present disclosure provides a management method related to real estate products. The management method includes following steps. A deal proceeded through a purchase certificate on a sale terminal is received, and the purchase certificate is related to digital money. A difference between deals by the purchase certificate and the corresponding home loan interest of the customer within the liquidation period is calculated. The difference to the finance organization server is provided to deduct the home loan interest within the liquidation period.

Based on the above, the real estate product related finance system and the management method thereof of the embodiment of this disclosure automatically calculates the purchase amount of the customer on a sale terminal, calculates the difference between total purchase amount and the home loan interest within the liquidation period (for example, one month, three months, half a year, etc.), and notifies the financial institutions of deduction results. In this way, it is convenient for the customer to manage and control their purchase, and it is more convenient for the financial institutions to manage and collect money. In addition, an innovative discounting mechanism the embodiment of the disclosure providing a total interest-free deductible home loan (total free of interest or the deduction ratio or upper deducted amount limit thereof determined by the purchase record of the customer) encourages the home loan customer to continue to use the purchase certificates (e.g., credit cards, mobile payments, etc.) issued by the financial institutions by realizing home loan interest deduction through purchasing. Additionally, the loyalty of home loan customer using sole purchase certificate is enhanced, which helps stimulate consumption and drives monetary circulation, and thus boosts economic development of the market.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a real estate product related finance system according to an embodiment of the disclosure.

FIG. 2 is a component block diagram illustrating a real estate service platform according to an embodiment of the disclosure.

FIG. 3 is a flow chart of a management method related to a real estate product according to an embodiment of the disclosure.

### DESCRIPTION OF THE EMBODIMENTS

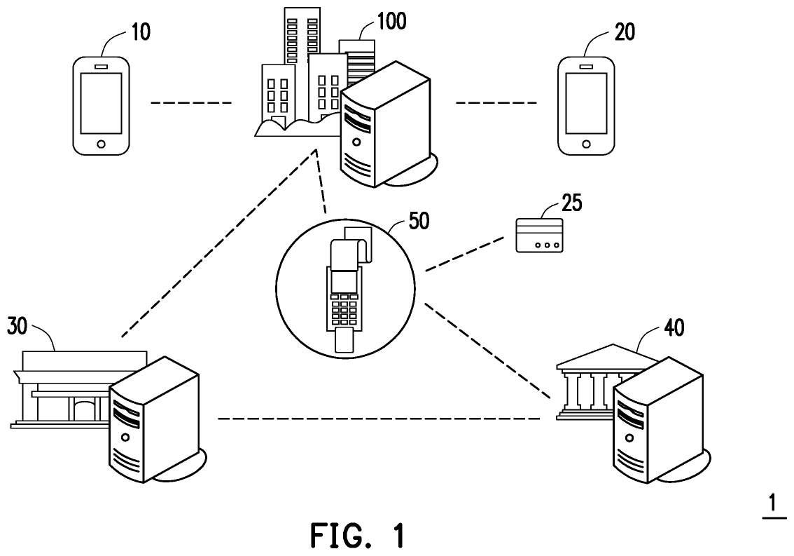

FIG. 1 is a schematic diagram of a real estate product related finance system according to an embodiment of the disclosure. A finance system 1 includes at least but not limited to a seller's customer terminal 10, a purchaser's customer terminal 20, a finance organization server 30 providing loans, a finance organization server 40 providing a purchase certificate 25, one or more sale terminals 50, and a real estate service platform 100.

The customer terminals 10 and 20 can be electronic devices such as smart phones, tablets, notebooks, and desktop computers. The customer terminal 10 and 20 include at least a network controller (for example, supporting 4G mobile communication , Wi-Fi, or Ethernet, and so on), a display device (for example, LCD or LED display, etc.), and a processor (for example, CPU, microprocessor, or application-specific integrated circuit (ASIC), and so on) to connect to the Internet, display the user interface or notify and perform computing functions. In this embodiment, the purchaser and the seller are the purchaser and the seller of real estate products (e.g., home, office, land, etc.).

The finance organization server 30 and the finance organization server 40 can be various types of servers, workstations, background hosts, and other electronic devices. The finance organization server 30 and the finance organization server 40 include at least a network controller (for example, supporting the 4G mobile communication, Wi-Fi, or Ethernet, and so on), a storage device (for example, HDD and SSD), and a processor (for example, CPU, microprocessor, or ASIC, and so on) to connect to the Internet, record the home loan information (for example, home loan interest, contract periods, principals, total loan amortization, home loan debit accounts, and trust accounts, etc.) or deal information (for example, the purchase certificate 25, the purchase amount, etc.) of the customer (i.e., the home loan) and perform computing functions. In this embodiment, the finance organization server 30 providing loans represents a server set up by the financial institution that provides customers loans, and the finance organization server 40 providing the purchase certificate 25 represents a server set up by the financial institution that issues or manages the purchase certificate 25. In addition, the purchase certificate 25 is a digital wallet (for example, third party payment, online banking, etc., provided by the financial institution (e.g., a bank or an insurance company). It can be a payment product, such as a credit card, a debit card, a stored-value card, and a physical card or a virtual card (for example, mobile payment).

A sale terminal 50 can be a physical terminal of a physical store (e.g., a card reader, a credit card machine, or a scanner (for one-dimensional or two-dimensional barcodes)), or a checkout platform of an online store (e.g., a credit card network, a digital wallet, a third-party payment platform, etc.), and connects with the financial institution server 40 that provides the purchase certificate 25 to provide the deal information (e.g., the purchase certificate 25 that is used, purchase amount, etc.).

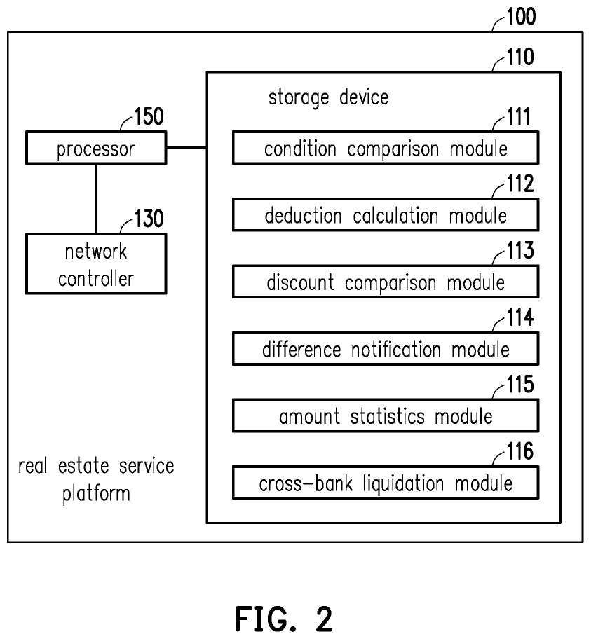

The real estate service platform 100 can be an electronic device such as a computer host, a server, a background host, etc. FIG. 2 is a component block diagram illustrating the real estate product related finance system 100 according to an embodiment of the disclosure. Please refer to FIG. 2, the real estate service platform 100 includes at least but not limited to a storage device 110, a network controller 130, and a processor 150.

The storage device 110 can be any type of fixed or removable storage device random access memory (RAM), read-only memory (ROM), flash memory, hard disk drive (HDD), solid-state drive (SSD), or the like or a combination of the above elements. In this embodiment, the storage device 110 is configured to store buffered or permanent data, software modules (for example, a condition comparison module 111, a deduction calculation module 112, a discount comparison module 113, and a difference notification module 114, an amount statistics module 115, and a cross-bank liquidation module 116, etc.), applications, home loan information, deal information, published product information, product demand, as well as other information or files, and the details of which are to be described in the following examples.

The network controller 130 can be a communication transceiver supporting 4G mobile communication, Wi-Fi, Ethernet, optical network, and so on to connect to the Internet.

The processor 150 is coupled to the storage device 110 and the network controller 130, and may be a central processing unit (CPU), or other programmable microprocessor for general purposes or special purposes, a digital signal processor (DSP), the ASIC, other similar component or combination of the above components. In the embodiment of this disclosure, the processor 150 is configured to perform all operations of the real estate service platform 100, and can load and perform each of software modules, files and data recorded by the storage device 110.

For easier understanding of the operation process of the embodiment of the present disclosure, the process flow of the finance system 1 for real estate products in the embodiment of the present disclosure will be described in detail below by various embodiments. Hereinafter, the methods described in the embodiments of the present disclosure will be described in conjunction with each device of the finance system 1 and various components and modules of the real estate service platform 100. Steps of the management method may be adjusted according to the situation of implementation, which is not limited thereto.

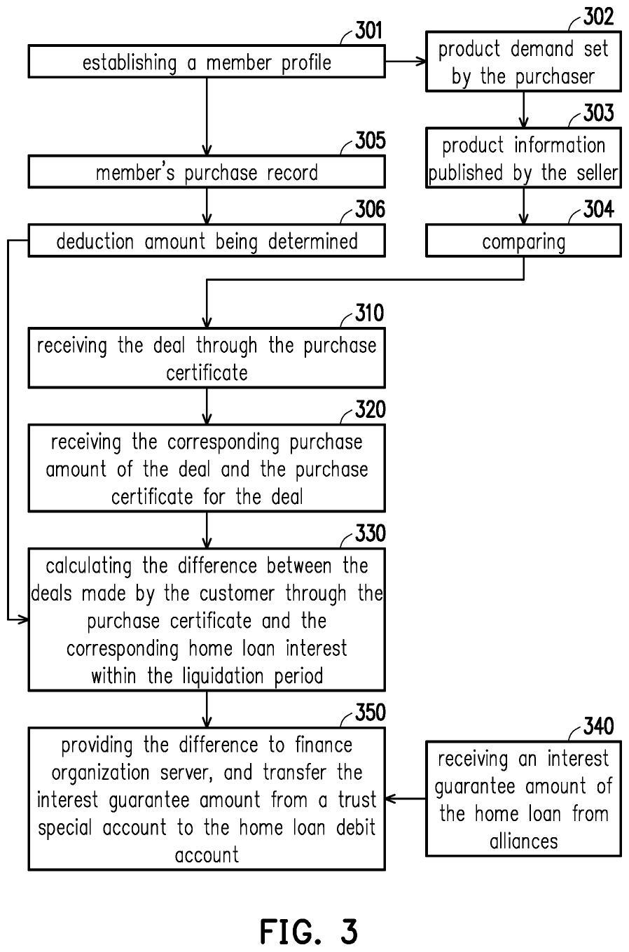

FIG. 3 is a flow chart of a management method related to a real estate product according to an embodiment of the disclosure. Please refer to FIG. 3. The real estate service platform 100 sets up a real estate deal website for the seller to publish the real estate products, for the purchaser to search for real estate products, and for an agent or salesperson to deal with the real estate business. The user establishes a member profile through the customer terminal 10 or 20 on the real estate deal website (step S301), so that the real estate service platform 100 provides the member profile to the customer. Identification, contact information, finance information, and guarantor information can be recorded in the member profiles. When the purchaser has the demand to buy a house, rent a house, purchase land, etc., the purchaser can use the customer terminal 20 to connect to the real estate deal website and input search conditions (for example, square of feet, setting, type, etc.) (Step S302). The real estate products that meet the search conditions are thus obtained. On the other hand, when the seller has the real estate, such as an apartment, a building, a parking space, a land, etc. for sale or for rent, the seller can use the customer terminal 10 to connect to the real estate deal website and input (or provide) the related published product information (for example, region, square of feet, age of house, setting, etc.) (Step S303), and the real estate products are published on the real estate deal website accordingly.

It should be noted that, in the embodiment of the present disclosure, exclusive product demands (for example, region, type, total price, square of feet, and related real estate product conditions) on the real estate deal website of the real estate service platform 100 is set by the purchaser's customer terminal 20. In addition, the condition comparison module 111 of the real estate service platform 100 determines whether all or the latest published product information of the current record meets the product demands of the purchaser's customer terminal 20 based on a designated time (for example, daily, weekly, monthly, etc.) or in response to certain numbers (for example, one, ten, twenty records, etc.) of the latest published product information (Step S304). When there is any one or more of the published product information that meets the product demand, the condition comparison module 111 immediately provides the matched published product information to the purchaser's customer terminal 20 through the network controller 130. For example, the real estate service platform 100 notifies the purchaser's customer terminal 20 by means of text messages, push notifications, emails, or the like. In this way, the purchaser does not have to spend too much time searching for products, and there is no demand for them to worry that better real estate products will be taken a step ahead by others.

On the other hand, the amount statistics module 115 of the real estate service platform 100 can also record each member profile on the sale terminal 50 or the purchase amount and the payment record dealt on the e-commerce platform as the member's purchase record corresponding to the member profile (step S305). For example, the member profiles can be recorded on a member carrier (e.g., a membership card, a smart card, a mobile payment carrier, etc.) or an electronic account (which can be linked to the e-commerce platform). When the member carrier is dealt on the sale terminal 50 or the electronic account is dealt on the particular e-commerce platform, the corresponding purchase amount and payment record are recorded in the member's purchase record by the amount statistics module 115. That is, as long as the customer establishes the member profile on the real estate service platform 100 (that is, no real estate deals yet), subsequent deals are recorded in the member's purchase record. In addition, the member's purchase record can be used as the basis for the upper deduction amount limit for the subsequent home loan interest. (Step 5306, and the details of how to determine the deduction amount will be described in detail later.).

For example, a company that launches the real estate service platform 100 provides registered members with physical or virtual membership cards and informs them that they can enjoy a certain percentage of purchase feedback (for example, cash back or points) by using of the membership cards in the common or designated channels. The customers make purchases by using the membership card on the purchase certificate 25 or the e-commerce platforms. The amount statistics module 115 also simultaneously records to the corresponding member's purchase record.

It should be noted that when the purchaser logs into the real estate service platform 100 to purchase real estate objects, apart from setting the conditions for the desired real estate objects, property information, such as personal income, liabilities and other related credit ratings, and so on (applied as the aforementioned member's profile) are provided in advance. On the other hand, the seller publishes real estate objects for sale on the real estate service platform 100, the member's profile is linked to the complete information (e.g., address, floor, building structure, year of construction, area of usage, etc.) of the published real estate objects.

Once the condition comparison module 111 of the real estate service platform 100 searches the seller's real estate objects that meets the purchaser's demands, the condition comparison module 111 immediately provides the matched published product information to the purchaser's customer terminal 20. The purchaser merely demands to select the real estate object to be purchased in the user interface of the customer terminal 20. The condition comparison module 111 matches the property information, such as credit rating registered by the purchaser with the related information of the selected real estate objects, and sends it to the home loan pre-calculation system of the finance organization server 30 that provides the home loans. After the finance organization server 30 audits the pre-calculation, a loan audit report is sent back to the real estate service platform 100. The condition comparison module 111 further sends complete information (e.g., address, floor, building structure, year of construction, area of usage, audited amount, etc.) together with the purchaser's related property information (e.g., credit rating information, such as income, debt, or withholding certificate) onto a property insurance pre-calculation system. In addition, after the property insurance pre-calculation, the property insurance pre-calculation result is sent back to the real estate service platform 100. That is, the real estate service platform 100 obtains a loan audit report and a property insurance pre-calculation result based on published product information and the property information of the purchaser. In addition, these results can be further sent to the purchaser's customer terminal 20 to browse.

In this way, the purchaser obtains the loanable amount, the house loan interest rate, the loan period and the (residential fire and earthquake insurance) property insurance fees of the selected real estate houses published by the seller before the beginning of seeing the object. At this time, the purchaser is able to specifically select the real estate within their financial capacity. There is no demand for them to spend time selecting real estate objects are out of their financial capacity due to insufficient credit amount (insufficient down payment).

Then, after a contract is signed by both of the purchaser and the seller, the purchaser may seek the financial institutions to make loans. The real estate deal website provides the related loan information of the financial institutions for the purchaser to select the particular financial institution or a loan program. For example, the purchaser applies for the home loan and the purchase certificate 25 issued by the financial institution according to the 70% of the amount of the actual price of the purchase and sale regulations. The loan demand (for example, total loan amount, expected interest rate, number of periods, etc.) is set on the real estate deal website. The real estate service platform 100 sends the loan demand to the finance organization server 30 providing the loan through the network controller 130. After the purchaser and the financial institution verify the identities and sign the contract, the finance organization server 30 provides the home loan information and the purchase certificate 25 related information to the real estate service platform 100. The purchase certificate 25 provided by the finance organization server that can be used by the customer (the home loan customers) during the contract period (or the home loan liquidation period), and the home loan information of the customer are set by the real estate service platform 100.

When the customer purchases in a store, the payment can be made at the sale terminal 50 of the store through the obtained purchase certificate 25. Furthermore, when the sale terminal 50 receives the deal through the purchase certificate 25, the sale terminal 50 (or the finance organization server 40) provides the deal information, such as the purchase amount corresponding to the deal and the purchase certificate 25 used in the deal to the real estate service platform 100 (Step 310). The real estate service platform 100 receives the deal information (for example, purchase information (including the purchase item and the purchase amount), the deal, etc.) dealt by the purchase certificate 25 from the sale terminal 50 (or the finance organization server 40) through the network controller 130 (Step 320).

After receiving the deal information provided by the sale terminal 50 (or the finance organization server 40), the deduction calculation module 112 of the real estate service platform 100 determines whether the purchase certificate 25 is related to the home loan contract between the home loan customer and the finance organization, and thus determines whether the deal occurs within the contract period (the home loan liquidation period). The deduction calculation module 112 searches the home loan interest of the corresponding customer through the purchase certificate 25, calculates a residual deductible interest within the liquidation period (for example, a month, a quarter, half a year, etc.) based on the purchase amount of the current deal, and immediately provides the residual deductible interest to the customer terminal 20 of the corresponding customer through the network controller 130 by means of text messages, push notifications, emails, or the like. It should be noted that he residual deductible interest may be a difference between the home loan interest within the liquidation period and the purchase amount previously dealt through the purchase certificate 25.

For example, the real estate service platform 100 has already recorded the home loan interest of the customer as 5,000 dollars, and the purchase amount of the purchase certificate 25 for the month is 1500 dollars. After the customer purchases a 300 dollars product through the purchase certificate 25, the deduction calculation module 112 calculates the residual deductible interest to be 5000−1500−300=3200 (dollars). The purchaser's customer terminal 20 of the customer notifies that the residual deductible interest to be 3200 (dollars). It this way, the customer immediately obtains the residual deductible interest after purchasing.

It should also be noted that the manner of banks monthly charging the home loan customer to repay the home loan may be adjusted the interest according to different stages. For example, the initial repayment of the principal is relatively lower, but the interest is relatively higher. Then, gradually, the post repayment of the principal is relatively higher, but the interest is relatively lower. However, the deduction calculation module 112 notifies the difference in home loan interest rates within the liquidation period to each of the purchaser's customer terminal 20, or directly provides the purchaser's customer terminal 20 with the current residual deductible interest of the home loan interest through the network controller 130.

Moreover, the stores often sign contracts with the finance organizations or mobile payment providers. Therefore, when the home loan customer purchases in the stores by using the purchase certificate 25 issued and managed by the finance organization, the stores pay profit back to the financial organization or the mobile payment provider (for the influx of the additional home loan customers use the purchase certificate 25 to purchase). For example, when the home loan customer uses the purchase certificate 25 to purchase a product having an original price 100 dollars, the store provides 10% discount to the finance organization (or the mobile payment provider). That is, the finance organization (or the mobile payment providers) merely demands to pay 90 dollars to the store.

In one embodiment, after the real estate service platform 100 receives the deal information through the purchase certificate 25, the discount comparison module 113 determines whether the purchase target is sold at the original price. If it is sold at the original price, the discount comparison module 113 provides the finance organization server 30 with discounted price paid by the stores and signed by the stores through the network controller 130. Yet, the discounted price may be the same or different from the discounted price of the finance organization (or the mobile payment provider) that issues/manages common payment products.

In another embodiment, the discount comparison module 113 of the real estate service platform 100 further obtains the discount information of the stores corresponding to the sale terminal 50 (e.g., promotion, special offers, discounts, etc.) or collects market information through the Internet, market researches to prevent the stores from not actively informing the finance organization (or the mobile payment provider) of providing discounts to the home loan customer and general consumers for their own interests. When there is a difference between the purchase amount and the discount information for a certain deal, the discount comparison module 113 provides the difference to the finance organization server 30 through the network controller 130 to prevent the stores from not actively informing the finance organization (or the mobile payment provider) of providing discounts to the home loan customer and common consumers for their own interests.

Then, when one of the liquidation period is due, the deduction calculation module 112 calculates the difference between the deals made by each of the customer through the purchase certificate 25 and the corresponding home loan interest within the liquidation period (Step 330). For example, if a customer spends 3,600 dollars in the month through the purchase certificate 25 and the home loan interest for that month is 3900 dollars, the difference is 300 dollars.

Next, the difference notification module 114 provides the difference to the finance organization server 30 providing loans through the network controller 130, so that the home loan interest is deducted within the liquidation period. Specially, when the difference is that the total purchase amount of all deals exceeds or equals the home loan interest within the liquidation period, the difference notification module 114 may request the finance organization server 30 to fully deduct the home loan interest of the current month. On the other hand, when the difference is that the total purchase amount of all deals is lower than the home loan interest within the liquidation period, the difference notification module 114 can request the finance organization server 30 to deduct the home loan interest of the current month with the total purchase amount. The insufficient home loan interest (that is, the value of the house interest subtracted from the total purchase amount) is provided to the purchaser's customer terminal 20 by the real estate service platform 100 through the network controller 130 (that is, the difference between the deals through the purchase certificate 25 and the corresponding home loan interest of the customer being provided to the purchaser's customer terminal 20) to remind the customers to pay the amount by themselves.

It should be noted that the aforementioned embodiment is that all the purchase within the liquidation period can be deducted from the home loan interest to achieve 100% interest-free. However, in some embodiments, the upper deductible amount limit can be determined according to the customer's record purchase capacity, so as to achieve a 20, 50, or 80 percent % (i.e., calculated on the basis of the upper deductible limit of the actual home loan interest percentage).

Specifically, in Step 306, each of the member purchase record corresponding to the member profile is obtained, and the deduction calculation module 112 determines the total deal amount corresponding to the member purchase record within a certain liquidation period. The deduction calculation module 112 determines the upper deduction amount limit of the home loan interest within the certain liquidation period by the member's purchase record and the home loan interest corresponding to the customer or their member data. If the total deal amount corresponding to the highest, the lowest or average member's purchase record is greater than or equal to the home loan interest, the upper deduction amount limit for the certain liquidation period is the home loan interest. If the total deal amount corresponding to the highest, the lowest or average member's purchase record is lower than the home loan interest, the upper deduction amount limit for the certain liquidation period is the highest, the lowest or average the total deal amount. That is, the upper deduction amount limit is not greater than the amount corresponding to the member's purchase record within the liquidation period.

For example, the member's purchase record is 3,200 dollars/month in average. It should be assumed that the home loan interest in the future is 2,500 dollars per month, 2,500 dollars can be deducted from (based on the member's purchase record) from the home loan interest per month. It should be assumed that the home loan interest in the future is 3,800 dollars per month, merely 3,200 dollars can be deducted from (based on the member's purchase record) the home loan interest per month. The home loan interest and an additional 600 dollars should be repaid by the home loan customer. In this way, the more increased purchases the member made during the real estate purchase process, the more interest amount will be deducted from the home loan in the future. According to the member's purchase record, different discount degrees of the home loan interest will be given.

It should be noted that the above is an example based on the real estate website, and other platforms such as e-commerce platforms, banks or lending platforms may also provide the same or similar upper deducted amount limit for their members.

On the other hand, the amount statistics module 115 of the real estate service platform 100 receives and calculates a guarantee amount of the home loan interest from alliances (Step 340). In this embodiment, the alliance of enterprises is to adopt alliances for mutual benefits. An interest guarantee amount within the certain scope is provided by the alliance of enterprises to be deposited in the financial institution (a trust account of a specific customer). During the home loan repayment period of the home loan customer, the real estate service platform 100 issues instructions through the network controller 130 to receive the interest guarantee amount in the trust account monthly through the finance organization server and transfer it to the home loan debit account of the home loan customer. The home loan interest, which should be repaid by the home loan customer in the current month, is thus deducted (Step 350).

Since the aforementioned home loan interest-free mechanism effectively attracts their home loan customers and increase the issuance and usage of the purchase certificates, the real estate service platform 100 provides a platform to attract other companies to build up alliances.

For example, the home loan interest subsidy mechanism provided by a digital service platform expands the real estate market. The income from the real estate service platform 100 can be used as the interest guarantee amount. It is assumed that the deal amount of the real estate is 10 million. In the current regulation, the common agency service fee is set not to be charged more than 2% of the purchaser's payment and 4% of the seller's payment. The real estate company can charge a total of 6% of the service fee (2% for the purchaser and 4% for the seller) from the purchaser and the seller for a total of 600,000 dollars. However, there is no commission fee occurred for a deal dealt through the real estate website. Therefore, the real estate service platform 100 can charge 1.5% to each of the purchaser and the seller, that is, a total of 3% of the object publication and system management and maintenance fees from the purchaser and the seller. These fees are used as the interest guarantee amount.

In addition, for the deals made through the purchase certificate 25, the finance organization server usually provides feedback mechanisms, such as cash rebate, points, discounts by cooperating with different industries, etc., and the rebated cash can also be used as the interest guarantee amount. Furthermore, the finance organization makes profits through the issued purchase certificate 25, lending, and the related core business (for example, the interest between different types of deposits (such as demand deposit, demand savings deposit, time deposit, and so on) and loan, deal fees, annual fees, and so on, which are also used as the interest guarantee amount. The amount statistics module 115 extracts the deposits of different interest rates to the lowest lending rate.

In one embodiment, take the 20-year constant amortization home loan (with 2% annual interest rate) as an example. It is assumed that the target deal amount of the house is 10 million×(2% annual interest rate the loan amount is 70%=7 million dollars (that is, the total loan amount). According to 20-year constant amortization home loan, the total amount is 7 million dollars×(2% annual interest rate for 20 years)=8.499 million dollars. The total amount of the home loan interest for 20 years is 8.499 million dollars−7 million dollars (principal)=1.499 million dollars. In another embodiment, in the total of 7 million loans, 3.7 million is interest from loans and 3.3 million are zero-interest from loans. The total interest receivable for 20 years is 792,000 dollars. That is, the fund of the zero-interest loans is provided by a zero interest account. According to the aforementioned management method of the disclosure, a(n) (object publication and system management and maintenance) fee of 300,000 dollars is received by a house with a deal amount of 10 million dollars. However, with the 20-year of total interest of 1.49 million dollars, the rebated cash of 149,000 dollars is calculated after the purchase conversion. In addition, the business income of the related the business (credit card deal fee, annual fee, etc.) of the finance organization is 350,000. The total of the three exceeds 792,000 dollars, and 100% interest-free is thus achieved. On the other hand, before the finance organization server approves the home loan, a total of 3% of the object publication and system management and maintenance fees from the purchaser and the seller is prepaid. That is, 300,000 dollars is deposited to the trust special account guaranteed by the financial organization. (The interest guarantee amount of 300,000 dollars is used to subsidize the insufficient home loan interest rate of the actual interest receivable.) The home loan customer monthly withdraws the 300,000 dollars from the finance organization server 30 during the 20-year home loan payment period to subsidize the insufficient home loan interest rate of the actual interest receivable. If the amount is still insufficient, the business income of the related the business (credit card deal fee, annual fee, etc.) of the finance organization is also deposited in the trust account to subsidize the insufficient home loan interest rate of the actual interest receivable.

On the other hand, when the loan amount is too high and the number of people is too large, and the home loan is applied to the different finance organizations, the cross-bank liquidation module 116 searches the home loan information at the corresponding finance organization servers 30 for different users in combination of the loan mechanism. In addition, the total purchase amount of the deal dealt through the purchase certificate 25 is deducted according to the home loan interest that should be paid for the month or within other liquidation periods.

In summary, during the economic recession, an innovative discounting mechanism the embodiment of the disclosure providing a total interest-free deductible home loan (zero interest rate) is necessary to effectively increase the real estate purchase demand and expand domestic consumption, and then the market is activated. In the real estate product related finance system and management method thereof the embodiment of the present disclosure, the purchaser actively provides the product demand matched notification and provides the loan and insurance information, so as to avoid excessive search time and accelerate the deal process. After the finance organization approves the loan and provides the purchase certificate, if the customer makes purchases through the purchase certificate, the real estate service platform automatically provides the customer with the residual deductible interest within the liquidation period after their purchase amount is deducted. Therefore, the customer immediately obtains the residual deductible interest. In addition, when the liquidation period expires, the real estate service platform notifies the finance organization of the difference between the total purchase amount and the home loan interest, so that the finance organization server obtains the corresponding home loan interest from the trust special account. On the other hand, the upper deductible amount limit for the home loan interest can be fixed or dynamically adjusted based on the member's purchase record, and different levels of the home loan interest are thus provided.

Although the disclosure is disclosed as the embodiments above, the embodiments are not meant to limit the disclosure. Any person skilled in the art may make slight modifications and variations without departing from the spirit and scope of the disclosure. Therefore, the protection scope of the disclosure shall be defined by the claims attached below.

What is claimed is:

1. A real estate product related finance system, comprising:
a finance organization server, recording home loan information of at least one customer, wherein the home loan information comprises home loan interest;
at least one sale terminal, receiving deal proceeded through a purchase certificate, wherein the purchase certificate is related to digital money; and
a real estate service platform, calculating a first difference between the deal by the purchase certificate and a corresponding home loan interest of the customer within a liquidation period, and providing the first difference to the finance organization server to deduct the home loan interest within the liquidation period.

2. The real estate product related finance system according to claim 1, further comprising:
at least one customer terminal, wherein
when the at least one sale terminal receives the deal proceeded through the purchase certificate, a purchase amount corresponding to the deal and the purchase certificate used in the deal are provided;
the real estate service platform searches the home loan interest of the customer corresponding to the purchase certificate, calculates a residual deductible interest within the liquidation period based on the purchase amount, and immediately provides the residual deductible interest to the customer terminal of a corresponding customer, wherein the residual deductible interest is related to the home loan interest and the purchase amount previously dealt through the purchase certificate within the liquidation period;
when the first difference is that the deal through the purchase certificate of each of the customer within the liquidation period is insufficient to the home loan interest, the real estate service platform provides the first difference to the customer terminal of the corresponding customer; and
the real estate service platform obtains at least one discount information, whereas when there is a second difference between the purchase amount corresponding to the deal and the discount information, the real estate service platform provides the second difference to the finance organization server.

3. The real estate product related finance system according to claim 1, further comprising:
at least one customer terminal, wherein
the real estate service platform provides at least one member profile of the customer terminal, and records a purchase amount and payment record of the member profile as a member's purchase record, wherein the member profile is recorded in a member carrier or an electronic account, the deal of the member carrier on the at least one sale terminal is recorded to the member's purchase record, and the deal of the electronic account on an e-commerce platform is recorded to the member's purchase record; and
the real estate service platform calculates each of the member's purchase record of the member profile within the liquidation period, and in response to receiving the home loan information provided by the finance organization server, the real estate service platform determines an upper deducted amount limit of the home loan interest within the liquidation period based on a corresponding member's purchase record and the home loan interest of the customer, wherein the upper deducted amount limit is not greater than an amount corresponding to the member's purchase record within the liquidation period.

4. The real estate product related finance system according to claim 1, further comprising:
at least one customer terminal, wherein
the customer terminal of a purchaser sets a product demand on the real estate service platform;
the customer terminal of a seller publishes a product information on the real estate service platform; and
when the product information meets the product's product demand, the real estate service platform immediately provides the matched product information to the customer terminal of a corresponding purchaser.

5. The real estate product related finance system according to claim 4, wherein
the real estate service platform obtains a property information corresponding to the customer terminal of the purchaser, wherein the property information related to income, debt, or credit rating; and
the real estate service platform obtains a loan audit report and a property insurance pre-calculation result based on the product information and the property information.

6. A management method related to real estate products, comprising:
receiving a deal proceeded through a purchase certificate on a sale terminal, wherein the purchase certificate is related to digital money;
calculating a first difference between the deal by the purchase certificate and home loan interest of at least one customer within a liquidation period; and
providing the first difference to a finance organization server to deduct the home loan interest within the liquidation period.

7. The management method related to real estate products according to claim 6, wherein before the step of receiving the deal through the purchase certificate through the sale terminal, further comprises:
obtaining a purchase amount corresponding to the deal and the purchase certificate used in the deal;
searching for the home loan interest of the customer corresponding to the purchase certificate;
calculating a residual deductible interest within the liquidation period based on the purchase amount, wherein the residual deductible interest is related to the home loan interest within the liquidation period and the purchase amount previously dealt through the purchase certificate;
immediately providing the residual deductible interest to a customer terminal of a corresponding customer;
when the first difference is that the deals by the purchase certificate of each of the customer within the liquidation period is insufficient to correspond to the home loan interest, the real estate platform providing the first difference to the customer terminal of the corresponding customer;
obtaining discount information of a corresponding store; and
when there is a second difference between a corresponding purchase amount of the deal and the discount information, the second difference being provided to the finance organization server.

8. The management method related to real estate products according to claim 6, wherein before the step of receiving the deal through the purchase certificate through the sale terminal, further comprises:
providing a member profile of the customer, and recording a purchase amount and payment record of the member profile as a member's purchase record, wherein the member profile is recorded in a member carrier or an electronic account, the deal of the member carrier on the sale terminal is recorded to the member's purchase record, and the deal of the electronic account on an e-commerce platform is recorded to the member's purchase record;
calculating the member's purchase record of the member profile within the liquidation period; and
in response to receiving home loan information provided by the finance organization server, determining an upper deducted amount limit of the home loan interest within the liquidation period based on a corresponding member's purchase record and the home loan interest of the customer, wherein the upper deducted amount limit is not greater than an amount corresponding to the member's purchase record within the liquidation period.

9. The management method related to real estate products according to claim 6, wherein before the step of the sale terminal receiving the deal through the purchase certificate further comprises:
receiving a product demand set by a customer terminal of a purchaser;
receiving product information proposed by a customer terminal of a seller; and
when the product information meets the product's demand, immediately providing the matched product information to the customer terminal of a corresponding purchaser.

10. The management method related to real estate products according to claim 9, wherein before the step of receiving the deal through the purchase certificate on the sale terminal further comprises:
obtaining a property information corresponding to the customer terminal of the purchaser, wherein the property information related to income, debt, or credit rating; and
obtaining a loan audit report and a property insurance pre-calculation result based on the product information and the property information.
